(19) United States
(12) Patent Application Publication
(10) Pub. No.: US 2026/0264447 A1
(43) Pub. Date: Sep. 10, 2026

(54) SEMI-TRAILER HUB CAP COVER WITH ZERK FITTING

(71) Applicants: Bryce Dalton, Circleville, UT (US); Lon Dalton, St. George, UT (US)

(72) Inventors: Bryce Dalton, Circleville, UT (US); Lon Dalton, St. George, UT (US)

(21) Appl. No.: 19/356,891

(22) Filed: Oct. 13, 2025

Related U.S. Application Data
(60) Provisional application No. 63/767,285, filed on Mar. 5, 2025.

(51) Int. Cl. B60B 7/00; B60B 7/06; F16N 21/02

(52) U.S. Cl. CPC B60B 7/0013; B60B 7/06; F16N 21/02; B60B 2900/561

(57) ABSTRACT

A non-vent axle hub cap features a dome forming a void for receiving a hub, a flange extending radially around the base of the dome, the flange having a plurality of securing apertures, and a grease zerk positioned in the top center of the dome. In some examples, the dome may feature a recess, with the zerk positioned within the recess and configured so that the top of the zerk is near, level with, or under the top of the dome. In use, when a user desires to add grease to the wheel bearings, a user may simply connect a grease gun to the zerk and pump in the desired amount of grease without the need of removing the hub cap.

### CROSS-REFERENCE TO RELATED APPLICATIONS

This application claims the benefit of U.S. Provisional Application Ser. No. 63/767,285 filed on Mar. 5, 2025, which is incorporated herein by reference.

### TECHNICAL FIELD

The present disclosure relates to semi-trailer hub caps. More particularly, the present disclosure relates to a zerk fitting integrated into a hub cap.

### BACKGROUND

Wheel bearings are critical components in the operation of semi-trailers, ensuring smooth and efficient rotation of the wheels. To function effectively and to avoid premature failure, wheel bearings must be kept adequately greased. Regular maintenance involving the application of grease is essential to prolong the lifespan of the bearings and to ensure the safe operation of the semi-trailer.

In semi-trailers equipped with hub caps, the process of greasing the wheel bearings typically requires the removal of the hub cap. This procedure is not only labor-intensive and time-consuming, but also presents several challenges and drawbacks. Firstly, the removal of the hub cap exposes the bearings to the risk of contamination by dirt and debris. Such contaminants can adversely affect the performance of the bearings, potentially leading to accelerated wear and failure.

Furthermore, the removal and subsequent reattachment of the hub cap necessitate the replacement of the hub cap seal. This additional step increases maintenance costs and adds complexity to the process. The hub cap seal is a crucial component that prevents the ingress of contaminants and ensures that the grease remains within the bearing assembly. Frequent replacement of the seal due to maintenance activities can lead to increased operational expenses for semi-trailer owners and operators.

Additionally, the hub cap itself may suffer damage during the removal process. This damage can compromise the integrity of the hub cap, leading to its premature failure and necessitating further replacements. Damaged hub caps can also contribute to the ingress of contaminants, exacerbating the risk of bearing failure and further increasing maintenance costs.

Given these issues, there is a clear need for an improved hub cap design that allows users to grease the wheel bearings without the need to remove the hub cap. Such a solution would streamline the maintenance process, reduce the risk of contamination, minimize the need for seal replacements, and prevent damage to the hub cap, ultimately leading to more efficient and cost-effective maintenance of semi-trailers. The present disclosure seeks to solve these and other problems.

### SUMMARY OF EXAMPLE EMBODIMENTS

In some embodiments, a non-vent axle hub cap comprises a dome forming a void for receiving the hub, a flange extending radially around the base of the dome, the flange comprising a plurality of securing apertures, and a grease zerk positioned in the top center of the dome.

In some embodiments, the dome may comprise a recess, with the zerk positioned within the recess and configured so that the top of the zerk is near, under, or level with the top of the dome.

### BRIEF DESCRIPTION OF THE DRAWINGS

FIG. 1 illustrates a side perspective cross-section of a semi-trailer hub cap with an integrated grease zerk;

FIG. 2 illustrates a top perspective view of a semi-trailer hub cap with an integrated grease zerk;

FIG. 3 illustrates a top plan view of a semi-trailer hub cap with an integrated grease zerk;

FIG. 4 illustrates a side elevation view of a semi-trailer hub cap with an integrated grease zerk;

FIG. 5 illustrates a bottom perspective view of a semi-trailer hub cap with an integrated grease zerk; and

FIG. 6 illustrates a top side perspective view of a semi-trailer hub cap with an integrated grease zerk coupled to a wheel of a semi-trailer.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there is a need for an improved hub cap design that allows users to grease the wheel bearings without the need to remove the hub cap. Such a solution would streamline the maintenance process, reduce the risk of contamination, minimize the need for seal replacements, and prevent damage to the hub cap, ultimately leading to more efficient and cost-effective maintenance of semi-trailers. The hub cap with integrated zerk disclosed herein solves these problems and others.

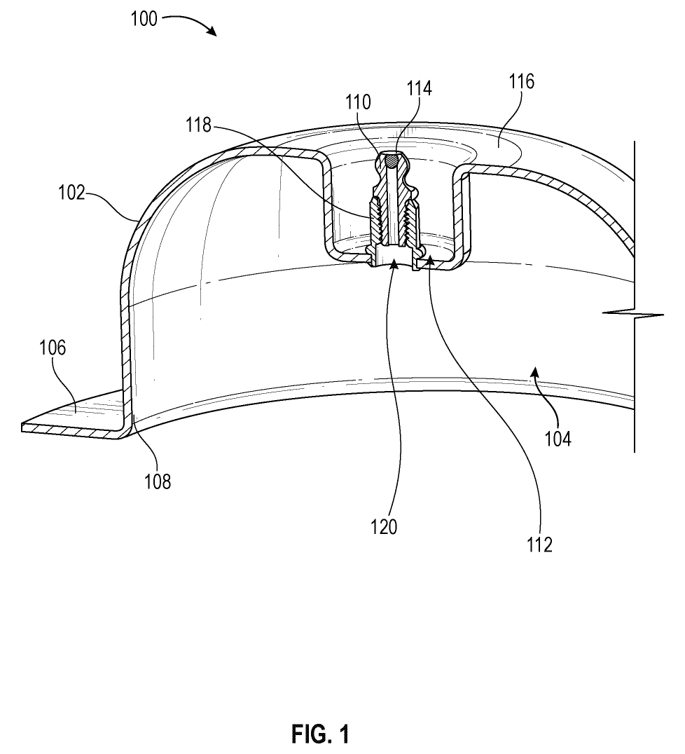

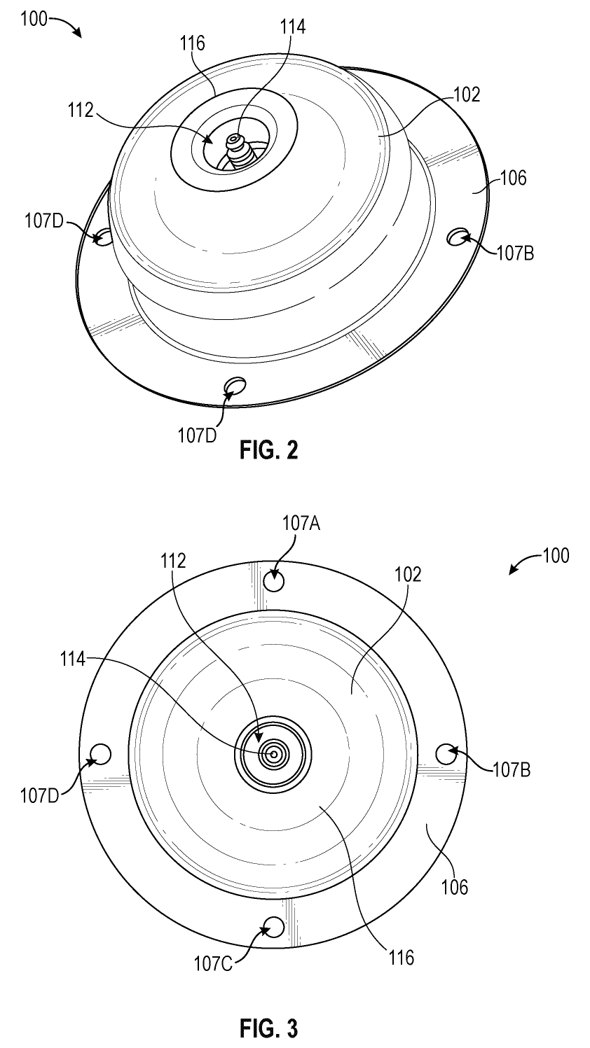

Referring to FIGS. 1-5, in some embodiments, a hub cap 100 (e.g., non-vent axle) comprises a dome 102 forming a void 104 for receiving a hub of a trailer wheel. A flange 106 extends radially outward around the base 108 of the dome 102 to couple to the wheel. For example, the flange 106 may comprise a plurality of securing apertures 107A-D (best seen in FIGS. 2-3 and 5) for receiving fasteners therethrough. The dome 102 further comprises a zerk 110 positioned in the top center of the dome 102. As appreciated, a user may connect a grease gun to the zerk 110 to insert grease into the wheel bearings without the need of removing the hub cap 100, saving time and reducing the need for additional replacement parts, like seals, and without risking damage to the hub cap 100.

In some embodiments, and as also shown in FIGS. 1-5, the dome 102 may comprise a recess 112 in the top center thereof, with the zerk 110 positioned within the recess 112 and configured so that the top portion 114 of the zerk 110 is near, level with, or under the top portion 116 of the dome 102. This ensures that the zerk 110 is not exposed (e.g., not protruding) or subject to external forces that could bend or otherwise damage the zerk 110. In some embodiments, the recess 112 may comprise a cap (not shown) to enclose the zerk 110 therein, providing additional protection to the zerk 110. Such a cap could comprise a twist and lock mechanism, a threaded coupling mechanism (which may be threaded on the recess 112 or may simply be threaded on the top portion 114 of the zerk 110), or simply be received in the recess 112 via interference fit.

The recess 112 comprises a zerk receiver 118 at the base thereof. As shown, the zerk receiver 118 extends outwardly through the center of the recess 112. The zerk receiver 118 comprises threads to facilitate mating with the zerk 110 (which may be a standard zerk known in the prior art). The zerk receiver 118 has a channel 120 therethrough that is configured to allow grease to flow through the zerk 110, through the channel 120, and into the bearings housed within the void 104.

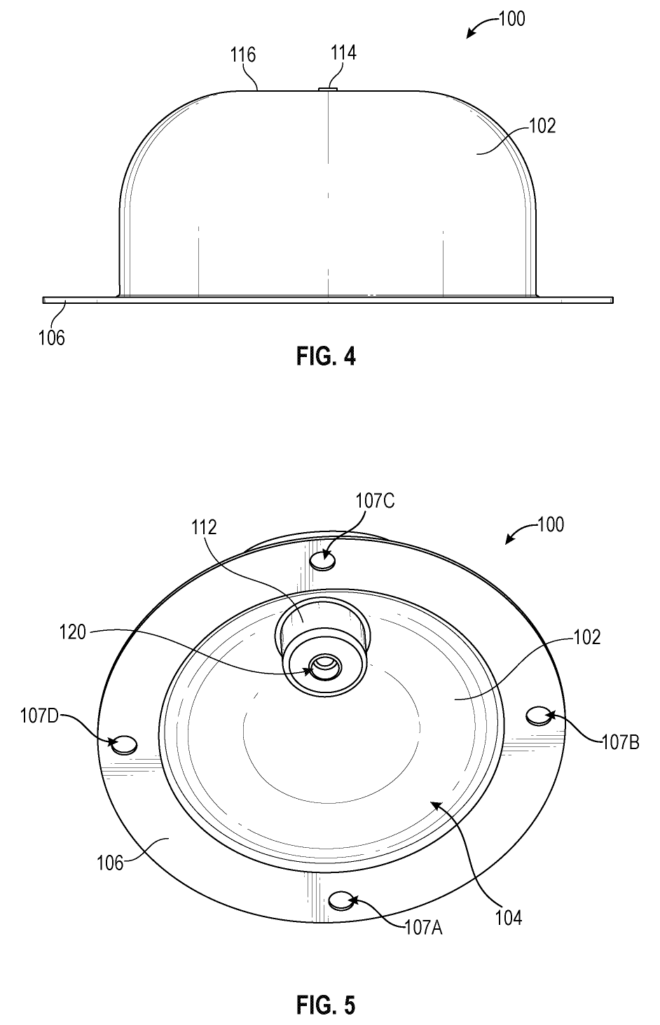

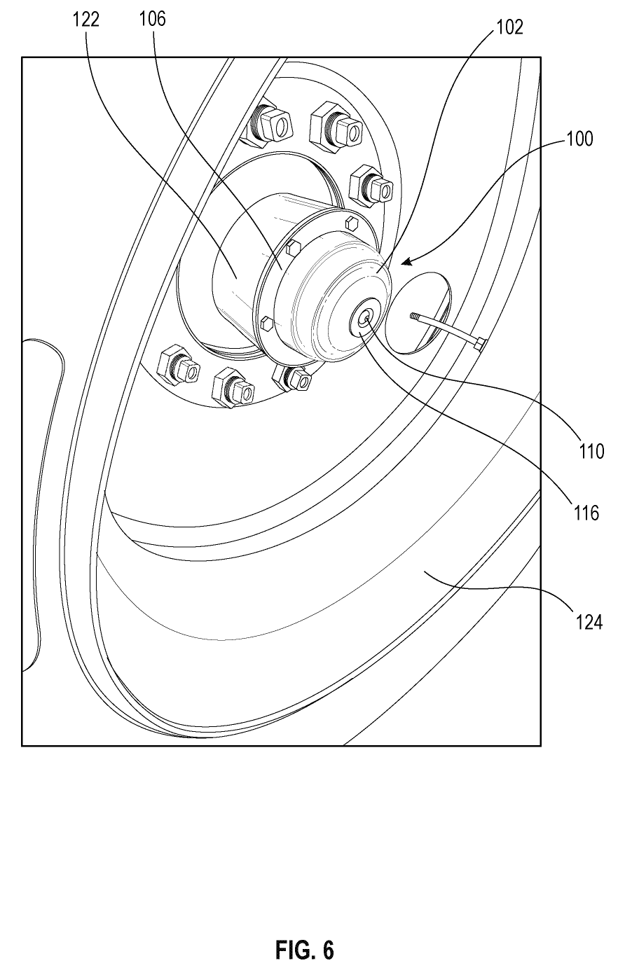

FIG. 6 illustrates the hub cap 100 coupled to a hub 122 of a wheel 124 of a semi-trailer. As understood, the hub cap 100 covers and seals the bearings within the hub 122, the hub cap 100 coupled to the hub 122 via the flange 106. Because the zerk 110 is counter-sunk into the dome 102 via the recess 112, it does not protrude (or if it does, very minimally such as shown in FIG. 4, so as to not pose a risk of exposure and breakage) past the top portion 116 of the dome 102. Accordingly, a user may grease the wheel bearings without removing the hub cap 100 by using the integrated zerk 110.

In use, when a user desires to add grease to the wheel bearings, a user may simply connect a grease gun to the zerk 110 and pump in the desired amount of grease without the need of removing the hub cap 100, overcoming limitations in the prior art. Accordingly, the hub cap 100 solves the need for a hub cap that allows a user to grease the bearings without the need for removing the hub cap. It will be appreciated that while the example discussed herein included semi-trailers, the hub cap 100 may likewise be used with other trailers or vehicles that have the same configuration.

It will be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein. Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A hub cap, comprising:
a dome;
a void formed by the dome;
a flange extending radially outward from a base of the dome; and
a hub zerk positioned at a top center of the dome.

2. The hub cap of claim 1, wherein the dome comprises a recess at the top center, the hub zerk positioned within the recess.

3. The hub cap of claim 2, wherein the recess comprises a zerk receiver configured to mate with the hub zerk.

4. The hub cap of claim 3, wherein the zerk receiver comprises a channel in a center thereof, the channel leading into the void.

5. The hub cap of claim 1, wherein the flange comprises a plurality of securing apertures.

6. A hub cap, comprising:
a dome;
a void formed by the dome;
a recess in a top portion of the dome;
a flange extending radially outward from a base of the dome;
a zerk receiver positioned within the recess; and
a hub zerk coupled to the zerk receiver.

7. The hub cap of claim 6, wherein the flange further comprises a plurality of securing apertures.

8. The hub cap of claim 6, wherein the zerk receiver comprises a channel in a center thereof, the channel leading into the void.

9. A method of greasing wheel bearings using a hub cap with an integrated hub zerk, the method comprising:
installing the hub cap with the integrated hub zerk onto a wheel;
coupling a grease gun to the integrated hub zerk; and
actuating the grease gun to insert grease through the integrated hub zerk and into a void containing the wheel bearings.

10. The method of claim 9, wherein the integrated hub zerk is positioned within a recess in the hub cap to avoid protruding outwardly therefrom, a user inserting the grease gun into the recess to couple to the integrated hub zerk.
